(19) United States
(12) Patent Application Publication
(10) Pub. No.: US 2024/0302697 A1
(43) Pub. Date: Sep. 12, 2024

(54) ACHROMATIC WAVE PLATES BASED ON COMPOUND TWISTED AND UNTWISTED NEMATIC LIQUID CRYSTAL POLYMER

(71) Applicant: Meta Platforms Technologies, LLC, Menlo Park, CA (US)

(72) Inventors: Sawyer MILLER, Bellevue, WA (US); Hsien-Hui CHENG, Woodinville, WA (US); Brian DAUGHERTY, Tucson, AZ (US); Hannah NOBLE, Berkeley, CA (US); Michael ESCUTI, Redmond, WA (US); Lu LU, Kirkland, WA (US)

(73) Assignee: Meta Platforms Technologies, LLC, Menlo Park, CA (US)

(21) Appl. No.: 18/119,911

(22) Filed: Mar. 10, 2023

(51) Int. Cl. G02F 1/13363; G02F 1/1334; G02F 1/1335

(52) U.S. Cl. CPC G02F 1/133638; G02F 1/1334; G02F 1/133526; G02F 1/133636; G02B 27/0172

(57) ABSTRACT

An achromatic wave plate using multiple twisted nematic liquid crystal polymer films or negative dispersion A-plate films is described. Each layer of twisted nematic liquid crystal polymer film aligns a next layer during forming achieving a monolithic structure. The achromatic wave plate with multiple layers of negative dispersion A-plate material has a non-continuous, easy to fabricate structure. Both types of films may be flexible and allow application to curved surfaces. The films of both examples also allow for high achromaticity in forward and backward propagation, thus, permitting the wave plate to operate as an optical isolator. A quarter wave of retardance across the entire visible spectrum and up to a 30-degree angle of incidence may be achieved.

### TECHNICAL FIELD

This patent application relates generally to optical lens assemblies, and specifically, to an achromatic wave plate component for an optical lens assembly based on nematic liquid crystal polymer.

### BACKGROUND

With the advance of optical and electronic technology fields, camera sizes are progressively decreasing while camera functionalities and capabilities are expanding. Miniaturized cameras may be found in wearable devices such as smart phones, smart watches, and smart glasses that may incorporate augmented reality (AR) and/or virtual reality (VR) functionality.

Some head-mounted displays (HMDs) rely on lens designs or configurations that are lighter and less bulky. For example, optical lens assemblies, also referred to as pancake optics, are commonly used to provide a thinner profile in certain head-mounted displays (HMDs). While various components of optical lens assemblies may be made from lighter and thinner material, their optical performance such as spectral or angular bandwidth may not be sufficient for certain applications.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1A illustrates a perspective view of a head-mounted display (HMD), according to an example.

FIG. 1B illustrates a perspective view of a near-eye display device in form of a pair of augmented reality (AR) glasses, according to an example.

FIG. 1C illustrates a top view of the near-eye display device in form of a pair of augmented reality (AR) glasses, according to another example.

FIG. 2 illustrates an optical lens assembly with an achromatic wave plate, according to an example.

FIG. 3 illustrates a twistable nematic liquid crystal element that may be used in an achromatic wave plate, according to an example.

FIG. 4 illustrates a spectral performance graph of an example achromatic wave plate with a twistable nematic liquid crystal and a single layer negative dispersion A-plate, according to an example.

FIGS. 5A through 5C illustrate angular performance graphs of the example achromatic wave plates with the twistable nematic liquid crystal and the multiple layer negative dispersion A-plate material in comparison with a single layer A-plate/C-plate, according to an example.

FIGS. 6A and 6B illustrate Poincare representations of material dispersion for the example achromatic wave plate with the twistable nematic liquid crystal and the single layer negative dispersion A-plate, according to an example.

FIG. 7 illustrates a flow diagram of a method for fabricating an achromatic wave plate with the twistable nematic liquid crystal material, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As used herein, a “near-eye display device” may refer to any display device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein, a “user” may refer to a user or wearer of a “near-eye display device.” A “wearable device” may refer to any portable electronic device that may be worn by a user and include a camera and/or a display to capture and/or present content to a user. Examples of “wearable devices” may include, but are not limited to, smart watches, smart phones, headsets, and near-eye display devices. An “optical lens assembly” also referred to as “pancake lens” as used herein refers to a plurality of optical lenses and other optical elements such as polarizers, quarter wave plates, filters, and similar ones that are assembled in alignment with an orthogonal axis relative to the individual components' planes.

Some optical lens assemblies for use in augmented reality (AR)/virtual reality (VR) near-eye display devices may include a reflective circular polarizer, with preferably large spectral and angular bandwidth for optical performance. In some implementations, a lamination surface of the reflective circular polarizer may need to be curved. A significant component of the circular polarizer is an achromatic quarter wave plate. Liquid crystal polymer may be laminated to a curved surface, while retaining its polarization characteristics. However, single layer achromatic wave plate/liquid crystal polymer films do not provide the spectral or angular bandwidth needed for optical performance of such optical lens assemblies.

In some examples of the present disclosure, a high spectral and angular bandwidth achromatic wave plate using multiple twisted nematic films or compound nematic films both utilizing negative dispersion material is described. One example achromatic wave plate may include a negative dispersion twisted nematic liquid crystal polymer film. The film may include multiple layers of twisted nematic material, where a previous layer aligns the next layer during forming. Thus, a monolithic structure is achieved. Another example achromatic wave plate may include films of negative dispersion A-plate material, thus, having a non-continuous, easy to fabricate structure. Both films may be flexible and allow application to curved surfaces. The films of both examples may also allow for high achromaticity in forward and backward propagation, thus, permitting the wave plates to operate as an optical isolator. In both cases, a quarter wave of retardance across the entire visible spectrum and up to a 30-degree angle of incidence may be achieved.

While some advantages and benefits of the present disclosure are apparent, other advantages and benefits may include a flexible and efficient achromatic wave plate with varying retardances (¼ wave, ½ wave, etc.) that allows application on curved surfaces. With a spectral bandwidth across the visible spectrum and an angle bandwidth of about 30 degrees, the wave plate may be used in augmented reality (AR)/virtual reality (VR) applications.

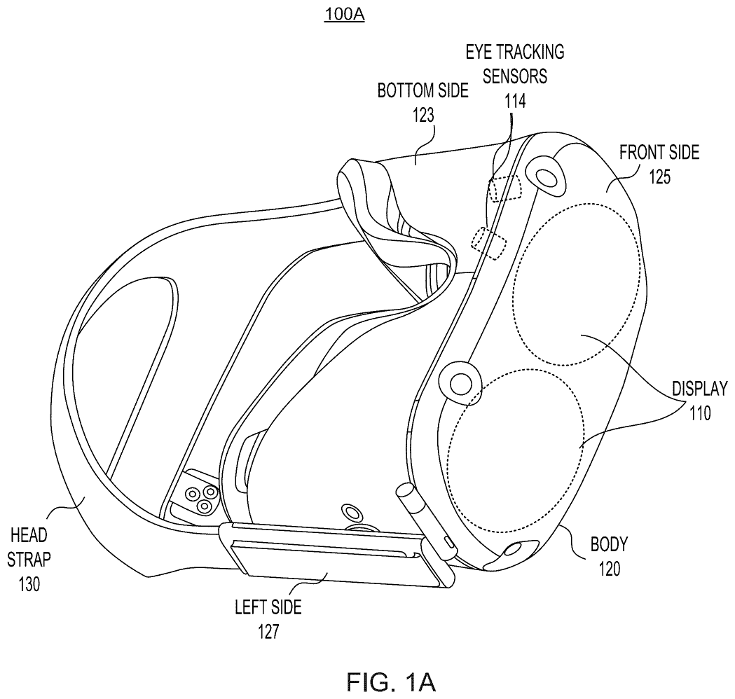

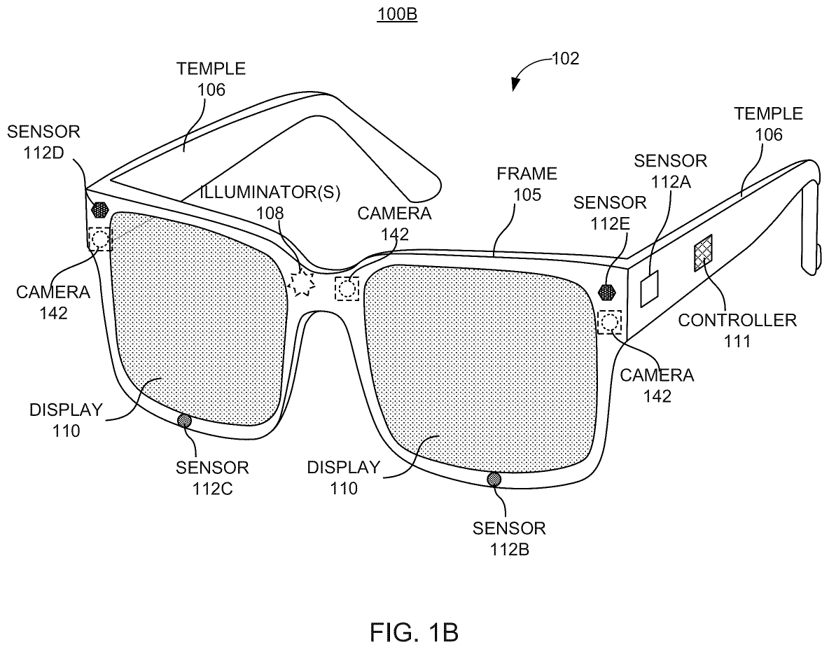

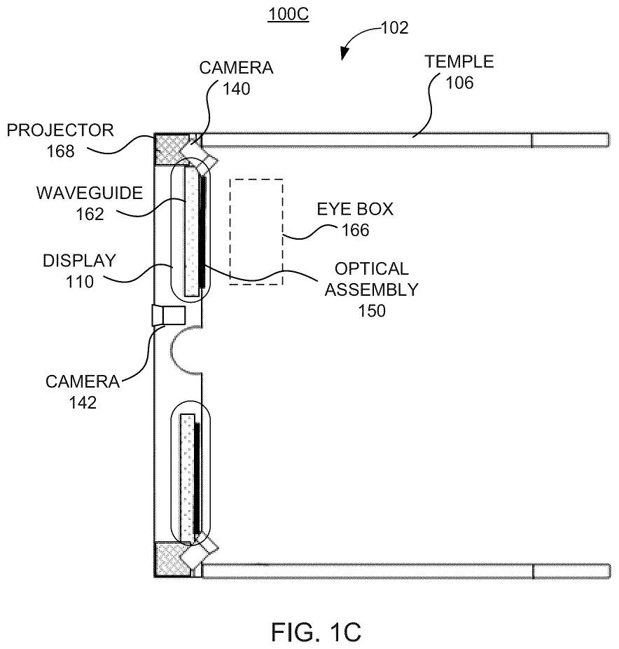

FIG. 1A shows a head-mounted display (HMD) 100A, in accordance with an example. The head-mounted display (HMD) 100A may include a front rigid body 120 and a head strap 130. A front side 125 of the body 120 may include an electronic display 110, an inertial measurement unit (IMU), one or more position sensors (e.g., eye tracking sensors 114), and one or more locators, as described herein. In some examples, a user movement may be detected by use of the inertial measurement unit (IMU), position sensors, and/or the one or more locators, and an image may be presented to a user through the electronic display 110 based on or in response to detected user movement. In some examples, the head-mounted display (HMD) 100A may be used for presenting a virtual reality, an augmented reality, or a mixed reality environment.

At least one position sensor may generate one or more measurement signals in response to motion of the head-mounted display (HMD) 100A. Examples of position sensors may include: one or more accelerometers, one or more gyroscopes, one or more magnetometers, another suitable type of sensor that detects motion, a type of sensor used for error correction of the inertial measurement unit (IMU), or some combination thereof. The position sensors may be located external to the inertial measurement unit (IMU), internal to the inertial measurement unit (IMU), or some combination thereof. In some examples, neither the inertial measurement unit (IMU) nor the position sensors may or may not necessarily be visible to the user.

Based on the one or more measurement signals from one or more position sensors, the inertial measurement unit (IMU) may generate calibration data indicating an estimated position of the head-mounted display (HMD) 100A relative to an initial position of the head-mounted display (HMD) 100A. In some examples, the inertial measurement unit (IMU) may rapidly sample the measurement signals and calculates the estimated position of the HMD 100A from the sampled data. For example, the inertial measurement unit (IMU) may integrate the measurement signals received from the one or more accelerometers (or other position sensors) over time to estimate a velocity vector and integrates the velocity vector over time to determine an estimated position of a reference point on the head-mounted display (HMD) 100A. Alternatively or additionally, the inertial measurement unit (IMU) may provide the sampled measurement signals to a console (e.g., a computer), which may determine the calibration data. The reference point may be a point that may be used to describe the position of the head-mounted display (HMD) 100A. While the reference point may generally be defined as a point in space; however, in practice, the reference point may be defined as a point within the head-mounted display (HMD) 100A (e.g., a center of the inertial measurement unit (IMU)).

FIG. 1B is a perspective view of a near-eye display device 102 in the form of a pair of glasses (or other similar eyewear), according to an example. In some examples, the near-eye display device 102 may be configured to operate as a virtual reality display, an augmented reality (AR) display, and/or a mixed reality (MR) display.

As shown in diagram 100B, the near-eye display device 102 may include a frame 105, two temples 106, and a display 110. In some examples, the display 110 may be configured to present media or other content to a user. In some examples, the display 110 may include display electronics and/or display optics. For example, the display 110 may include a liquid crystal display (LCD) display panel, a light-emitting diode (LED) display panel, or an optical display panel (e.g., a waveguide display assembly). In some examples, the display 110 may also include any number of optical components, such as waveguides, gratings, lenses, mirrors, etc. In other examples, the display 110 may include a projector, or in place of the display 110 the near-eye display device 102 may include a projector. The projector may use laser light to form an image in angular domain on an eye box for direct observation by a viewer's eye, and may include a vertical cavity surface emitting laser (VCSEL) emitting light at an off-normal angle integrated with a photonic integrated circuit (PIC) for high efficiency and reduced power consumption.

In some examples, the near-eye display device 102 may further include various sensors 112A, 112B, 112C, 112D, and 112E on or within a frame 105. In some examples, the various sensors 112A-112E may include any number of depth sensors, motion sensors, position sensors, inertial sensors, and/or ambient light sensors, as shown. In some examples, the various sensors 112A-112E may include any number of image sensors configured to generate image data representing different fields of views in one or more different directions. In some examples, the various sensors 112A-112E may be used as input devices to control or influence the displayed content of the near-eye display device, and/or to provide an interactive virtual reality (VR), augmented reality (AR), and/or mixed reality (MR) experience to a user of the near-eye display device 102. In some examples, the various sensors 112A-112E may also be used for stereoscopic imaging or other similar application.

In some examples, the near-eye display device 102 may further include one or more illuminators 108 to project light into a physical environment. The projected light may be associated with different frequency bands (e.g., visible light, infra-red light, ultra-violet light, etc.), and may serve various purposes. In some examples, the one or more illuminator(s) 108 may be used as locators.

In some examples, the near-eye display device 102 may also include a camera 142 or other image capture device. The camera 142, for instance, may capture images of the physical environment in the field of view. In some instances, the captured images may be processed, for example, by a virtual reality engine to add virtual objects to the captured images or modify physical objects in the captured images, and the processed images may be displayed to the user by the display 110 for augmented reality (AR) and/or mixed reality (MR) applications.

In some examples, one or more functionalities of the near-eye display device 102 may be managed by controller 111. For example, management of camera features associated with the near-eye display device 102 may be performed entirely or partially by the controller 111. In other examples, a remote controller communicatively coupled to the near-eye display device 102 may perform some or all of the functions.

FIG. 1C is a top view of a near-eye display device 102 in the form of a pair of glasses (or other similar eyewear), according to an example. As shown in diagram 100C, the near-eye display device 102 may include a frame 105 having a form factor of a pair of eyeglasses. The frame 105 supports, for each eye: a projector 168 such as any scanning projector variant considered herein, a pupil-replicating waveguide 162 optically coupled to the projector 168, an eye-tracking camera 140, and one in the center or two on each side (for stereo imaging) environment capturing camera 142. The projector 168 may provide a fan of light beams carrying an image in angular domain to be projected into a user's eye. A display 110 presenting content from the projector to an eye box 166 may include an optical lens assembly 150, which may include a number of optical lenses and other elements aligned along their orthogonal axes.

In some examples, multi-emitter laser sources may be used in the projector 168. Each emitter of the multi-emitter laser chip may be configured to emit image light at an emission wavelength of a same color channel. The emission wavelengths of different emitters of the same multi-emitter laser chip may occupy a spectral band having the spectral width of the laser source. The projector 168 may include, for example, two or more multi-emitter laser chips emitting light at wavelengths of a same color channel or different color channels. For augmented reality (AR) applications, the pupil-replicating waveguide 162 may be transparent or translucent to enable the user to view the outside world together with the images projected into each eye and superimposed with the outside world view captured by the camera 142. The images projected into each eye may include objects disposed with a simulated parallax, so as to appear immersed into the real-world view.

The eye-tracking camera 140 may be used to determine position and/or orientation of both eyes of the user. Once the position and orientation of the user's eyes are known, a gaze convergence distance and direction may be determined. The imagery displayed by the projector 168 may be adjusted dynamically to account for the user's gaze, for a better fidelity of immersion of the user into the displayed augmented reality scenery, and/or to provide specific functions of interaction with the augmented reality. Reflections (also referred to as “glints”) may function as reference points in the captured eye image, facilitating the eye gazing direction determination by determining position of the eye pupil images relative to the glints. To avoid distracting the user with illuminating light, the latter may be made invisible to the user. For example, infrared light may be used to illuminate the eye boxes 166.

Functions described herein may be distributed among components of the near-eye display device 102 in a different manner than is described here. Furthermore, a near-eye display device as discussed herein may be implemented with additional or fewer components than shown in FIGS. 1A and 1B. While the near-eye display device 102 is shown and described in form of glasses, a flat-surfaced, electrically controlled, tunable lens may be implemented in other forms of near-eye display devices such as goggles or headsets, as well as in non-wearable devices such as smart watches, smart phones, and similar ones.

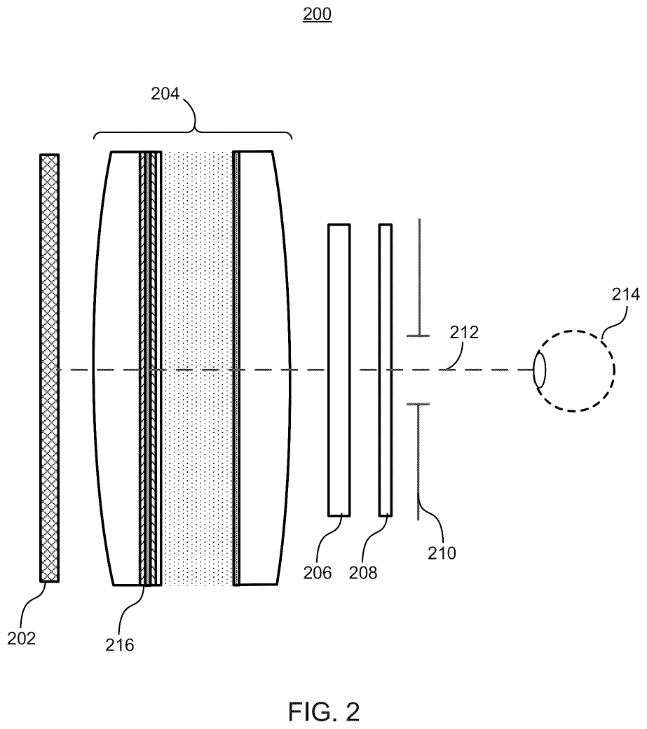

FIG. 2 illustrates an optical lens assembly with an achromatic wave plate, according to an example. Diagram 200 shows a display 202, an optical lens assembly 204, additional optical elements 206 and 208, and an aperture 210. Illumination 212 from the display 202 may traverse all these optical components in this assembly to create one or more visual images at an eye 214 of a user.

The display 202 may be similar to the display 110 described with respect to FIG. 1A, 1B, or 1C. The optical lens assembly 204 may include any number of optical components. In some examples, component 216 of the optical lens assembly 204 or one of the additional optical elements 206 and 208 may be a retarder, that is a wave plate such as an achromatic wave plate. Wave plates transmit light and modify its polarization state without attenuating, deviating, or displacing a light beam. Wave plates achieve this by retarding (or delaying) one component of polarization with respect to its orthogonal component.

Wave plates have a fast axis and a slow axis. Light polarized along the fast axis encounters a lower index of refraction and travels faster through the wave plate than light polarized along the slow axis. Retardation of a wave plate describes a phase shift between the polarization component projected along the fast axis and the component projected along the slow axis. Retardation may be specified in units of degrees, radians, waves, or nanometers. One full wave of retardation is equivalent to 360 degrees, for example. Commonly used wave plates may have a retardation at quarter wave (90 degrees), half wave (180 degrees), full wave. Achromatic wave plates include two different materials that practically eliminate chromatic dispersion and provide retardation across a wide spectrum. For example, some achromatic wave plates may be made from two birefringent crystalline materials to provide a constant phase shift independent of wavelength such as crystal quartz and magnesium fluoride. However, in miniaturized display systems of near-eye display devices and miniature cameras, making the optical lens assembly as thin as possible is a design goal and achromatic wave plates made from such materials may not reach the low thicknesses desired in such applications.

A single film of liquid crystal polymer may be laminated to a curved surface, while retaining its polarization characteristics. However, single layer achromatic wave plate/liquid crystal polymer films do not provide the spectral or angular bandwidth needed for optical performance of optical lens assemblies in augmented reality (AR)/virtual reality (VR) applications.

In some examples, an achromatic wave plate may include a negative dispersion twisted nematic liquid crystal polymer film. The film may include multiple layers of twisted nematic material, where a previous layer aligns the next layer during forming. Thus, a monolithic structure may be achieved providing high achromaticity in forward and backward propagation and permitting the wave plate to operate as an optical isolator. In other examples, an achromatic wave plate may include films of negative dispersion A-plate material, thus, having a non-continuous, easy to fabricate structure. An A-plate is a uniaxial birefringent optical element having its slow (extraordinary) axis oriented parallel to a plane of the wave plate. The negative dispersion A-plate material wave plate (with multiple layers) may also allow for high achromaticity in forward and backward propagation and permit the wave plate to operate as an optical isolator. In both cases, the films may be flexible and allow application to curved surfaces with a retardance across the entire visible spectrum and up to a 30-degree angle of incidence.

In some examples, the optical lens assembly 204 may include (as well as the additional optical components 206 and 208) a variety of optical elements, such as a Pancharatnam-Berry phase (PBP) lens (e.g., geometric phase lens (GPL)), a polarization sensitive hologram (PSH) lens, a polarization sensitive hologram (PSH) grating, a metamaterial (e.g., metasurface), a liquid crystal optical phase array, a light field lens such as a micro lens array (MLA), etc. The optical lens assembly 204 may include two or more optical elements having a gap in between them, thereby folding the optical distance and adding optical focus power. Surfaces of the individual elements may also be provided with any number of optical layers. These may include, but are not limited to, a reflective polarizer layer, a semi-transparent mirror, or other optical layer.

While the described arrangement of optical lens types and other optical elements, as well as, their material is one example, other configurations of the optical lens assembly with different types and/or numbers of optical lenses and using different types of material may also be implemented. For example, the optical lenses in the optical lens assembly may include concave, convex, plano-concave, plano-convex, and similar lenses. The assembly may also include other optical elements such as a filter, a polarizer, a phase plate, a quarter wave plate, and/or comparable ones.

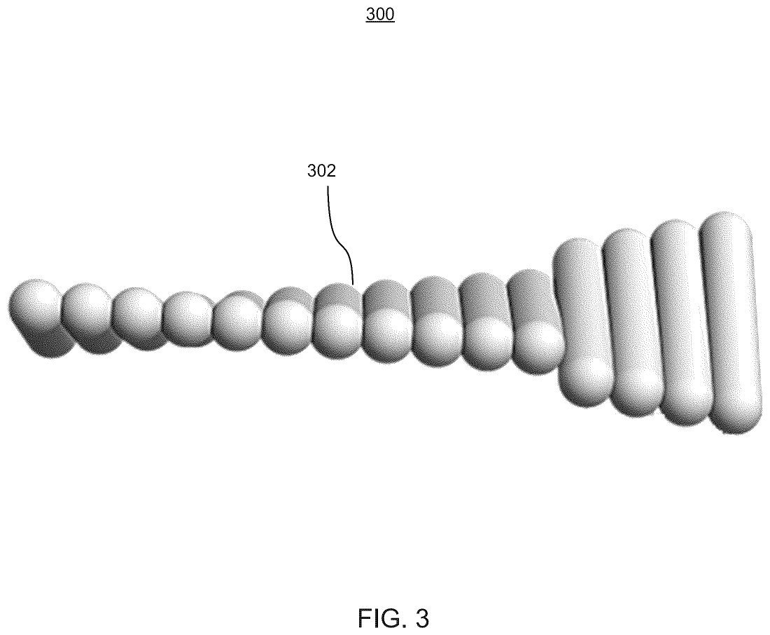

FIG. 3 illustrates a twistable nematic liquid crystal element that may be used in an achromatic wave plate, according to an example. Diagram 300 shows a twisted liquid crystal polymer ribbon 302. A shape change of liquid crystal polymers depends on alignment directions and relevant phase transitions such as nematic, cholesteric, smectic, or isotropic. The twisted nematic orientation may transform a liquid crystal polymer film from flat to spiral ribbons, resulting in complex controllable photomechanical behaviors such as broad-spectrum retardation. The nematic liquid crystal polymers may react with one another in the presence of a photo-initiator and UV light, for example, to form a rigid network. In solution form, the polymers may be coated onto flexible or curved substrates by a roll-to-roll or similar coating process forming monolithic retarders.

In some examples, as the nematic liquid crystal polymer film is applied in layers, each layer may align the next, thus, achieving a monolithic structure. In a practical implementation, a single layer of nematic liquid crystal polymer film with a pre-twist angle of 102.5 degrees and a twist angle of −80.2 degrees may be about 2.62 micrometers. A two layer film with a pre-twist angle of 22.3 degrees and a twist angle of −26.6 degrees may be about 6.02 micrometers. Thus, a desired reduction of optical lens assembly may be achieved with very thin achromatic wave plates.

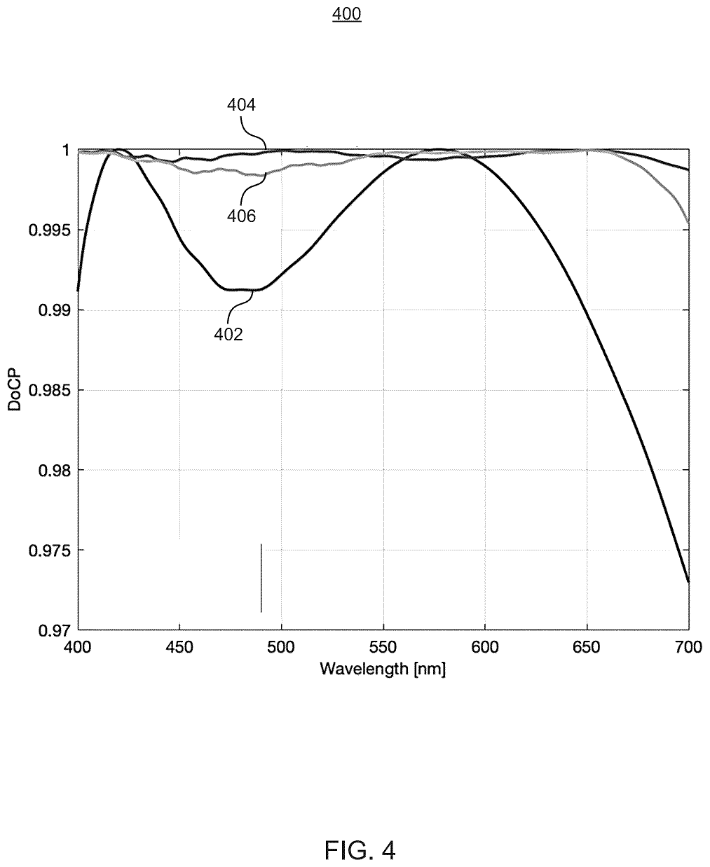

FIG. 4 illustrates a spectral performance graph of two example achromatic wave plates with a twistable nematic liquid crystal and a single layer negative dispersion achromatic wave plate, according to an example. Diagram 400 shows a spectral performance graph 402 of a single layer negative dispersion A-plate, a spectral performance graph 404 of an achromatic wave plate with multiple layers of negative dispersion twisted nematic liquid crystal polymer, and a spectral performance graph 406 of an achromatic wave plate with multiple layers of negative dispersion A-plate material.

As shown in diagram 400, the spectral performance graph 402 of a single layer negative dispersion A-plate includes variations across the visible spectrum with the performance dropping off at both ends of the spectrum, especially with a drastic drop at the high end (around 600 nanometers). The spectral performance graph 404 of an achromatic wave plate with multiple layers of negative dispersion twisted nematic liquid crystal polymer, on the other hand, is relatively flat with a high degree of circular polarization (DoCP) close to 1. The spectral performance graph 406 of an achromatic wave plate with multiple layers of negative dispersion A-plate material is similar to the graph for the twisted nematic liquid crystal polymer wave plate with a slight drop at the high end (around 680 nanometers). Thus, both example wave plates show significant improvement in spectral bandwidth, maintaining a quarter wave retardance over 300 nanometer spectral width.

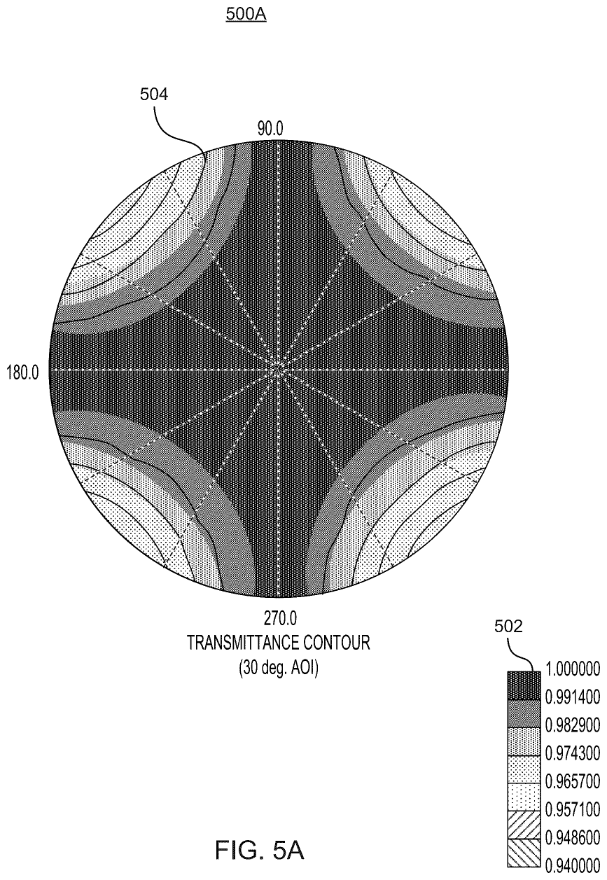

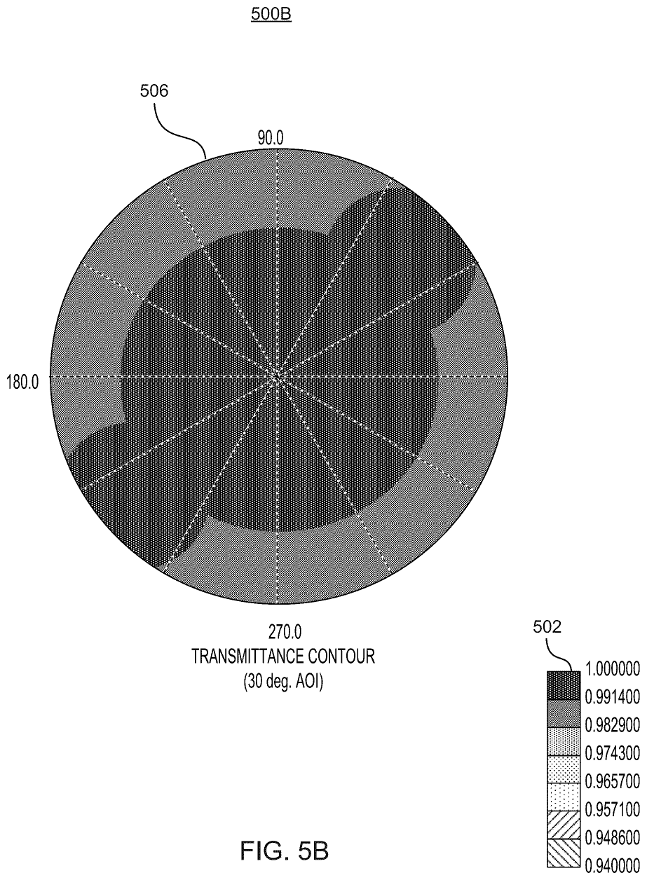

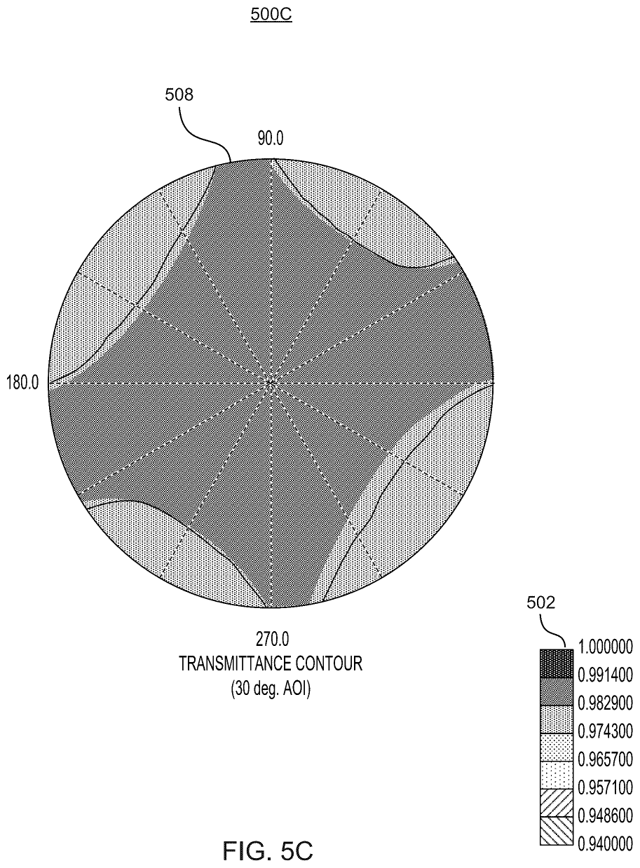

FIGS. 5A through 5C illustrate angular performance graphs of the example achromatic wave plates with the twistable nematic liquid crystal and the multiple layer negative dispersion A-plate material in comparison with a single layer A-plate/C-plate, according to an example.

Diagram 500A in FIG. 5A shows an angular performance graph (transmittance contour) 504 of an A-plate/C-plate retarder with a scale 502 indicating where the angular performance drops. The graph is provided for comparison with the spectral performance graphs (transmittance contours) of the two example wave plates in FIGS. 5B and 5C. The graph represents the performance at 550 nanometer wavelength with a 30 degree angle of incidence and right hand circular incident polarization. By providing additional twisting layers or combinations of A-plates, C-plates, and/or biaxial films, the angular bandwidth can be increased. 30 degrees is approximately the practical limit for a two-layer system.

Diagram 500B in FIG. 5B shows an angular performance graph (transmittance contour) 506 of an achromatic wave plate with twisted nematic liquid crystal polymer layers with the scale 502 indicating the angular performance levels. As the transmittance contour shows, at 550 nanometer wavelength with a 30 degree angle of incidence and right hand circular incident polarization, there is virtually no reduction in angular performance.

Diagram 500C in FIG. 5C shows an angular performance graph (transmittance contour) 508 of an achromatic wave plate with multiple layer negative dispersion A-plate material with the scale 502 indicating the angular performance levels. As the transmittance contour shows, at 550 nanometer wavelength with a 30 degree angle of incidence and right hand circular incident polarization, there is a slight reduction in angular performance for this example wave plate.

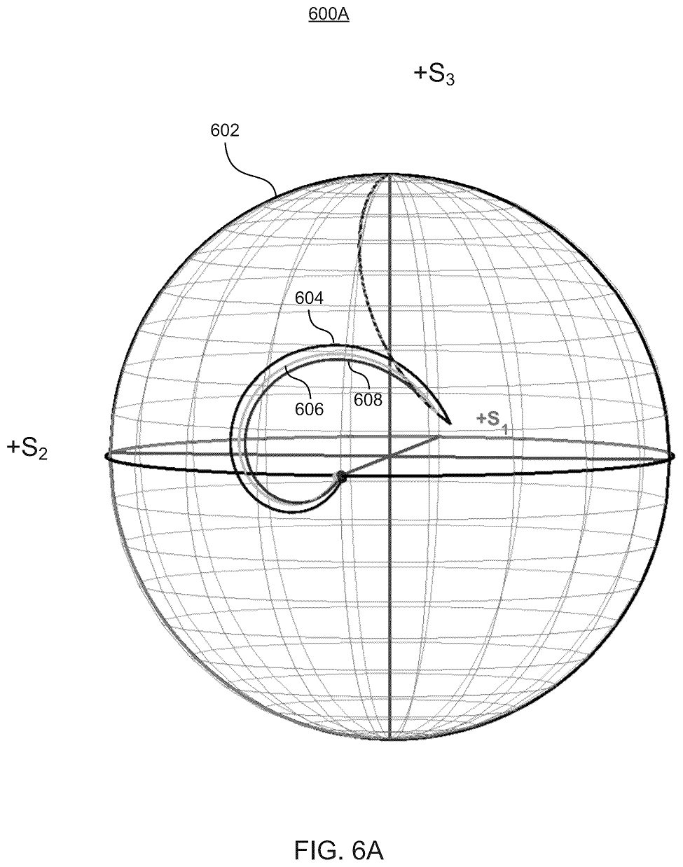

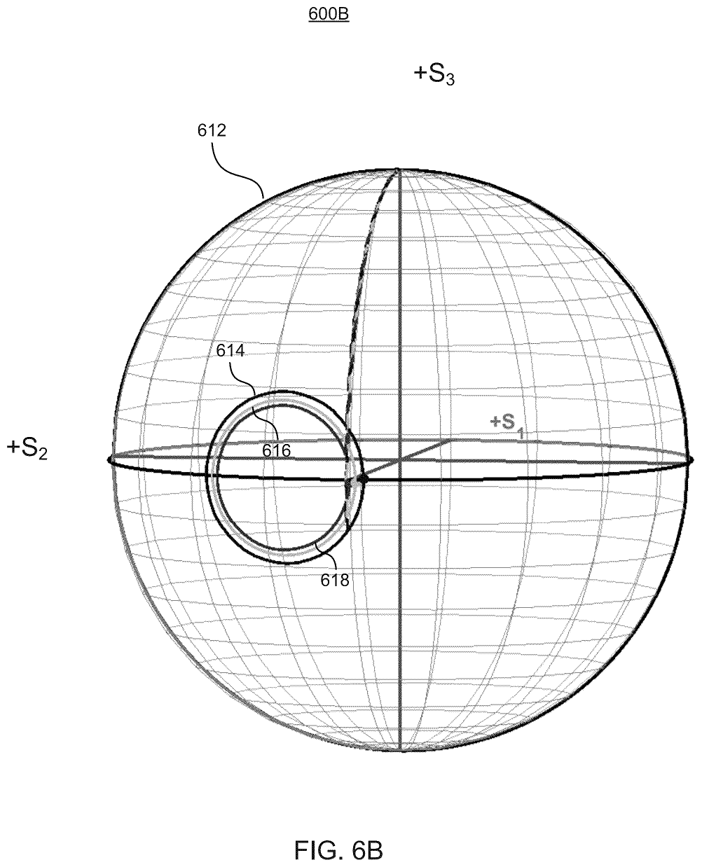

FIGS. 6A and 6B illustrate Poincare representations of material dispersion for the two example achromatic wave plates with a twistable nematic liquid crystal, according to an example. Diagram 600A and 600B show polarization state changes for the wave plate with twisted nematic liquid crystal polymer layers and the wave plate with multiple layer negative dispersion A-plate material, respectively. In Poincare sphere representation 602, blue (604), green (606), and red (608) wavelengths are shown along with the three axes S1, S2, and S3 of the sphere. Similarly, in Poincare sphere representation 612, blue (614), green (616), and red (618) wavelengths are shown along with the three axes S1, S2, and S3 of the sphere.

A Poincare sphere provides a visual technique for representing polarization states and calculating the effects of polarizing components. Each state of polarization is represented by a unique point on the sphere defined by its orientation of major axis, ellipticity, and handedness. In the representations of diagrams 600A and 600B, right hand circular polarization is used. Orthogonal polarizations occupy points at opposite ends of a sphere diameter. Propagation through retarders is represented by a sphere rotation that translates the polarization state from an initial point to a final polarization as shown by the curves for three different colors.

In some examples, for both, the wave plate with twisted nematic liquid crystal polymer layers and the wave plate with multiple layer negative dispersion A-plate material, pre-compensation techniques to properly account for the dispersion of the material may be used. Unique compensation schemes may be employed in each case. Some examples of compensation schemes may include, but are not limited to, (1) Pancharatnam 3-layer A-plate design, 2) Half-wave retarder combined with quarter-wave retarder, 3) Dispersion matching with combinations of multiple biaxial and uniaxial films, and 4) Removal of the compensation altogether and using a single slowly varying low dispersion film.

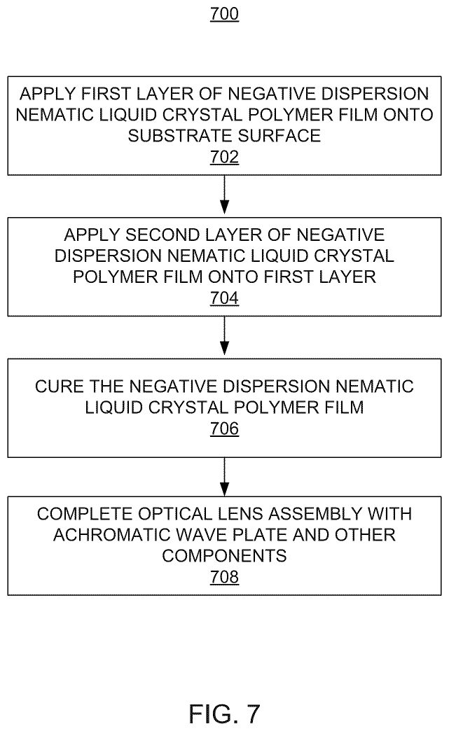

FIG. 7 illustrates a flow diagram of a method 700 for fabricating an achromatic wave plate with the twistable nematic liquid crystal material, according to an example. The method 700 is provided by way of example, as there may be a variety of ways to carry out the method described herein. The method 700 may be executed or otherwise performed by one or more processing components of a system or a combination of systems to implement other models. Each block shown in FIG. 7 may further represent one or more processes, methods, or subroutines, and one or more of the blocks may include machine readable instructions stored on a non-transitory computer readable medium and executed by a processor or other type of processing circuit to perform one or more operations described herein.

At block 702, a first layer of twisted nematic liquid crystal polymer may be applied onto a surface of a substrate. In some examples, the substrate may be an optical lens with a curved surface. As the liquid crystal polymer film is flexible, it may be applied onto a curved surface of an optical lens as opposed to a flat separate substrate, thereby reducing a thickness of the optical lens assembly.

At block 704, a second layer of the twisted nematic liquid crystal polymer may be applied onto the first layer. Each layer of the twisted nematic liquid crystal polymer may align the next layer. Thus, overall retardation performance (across a broad wavelength spectrum and with improved angular spectrum) may be achieved without specially treating each layer. The steps of applying the layers may be repeated as needed. In some examples, an adhesive or other intermediate layer may also be used between the film layers.

At block 706, the twisted nematic liquid crystal polymer film may be cured for example by using UV light. The substrate with the cured twisted nematic liquid crystal polymer film may then be aligned along an orthogonal axis along with other elements of the optical assembly and affixed through a variety of techniques (mechanical, chemical, etc.) at block 708.

According to examples, a method of making an achromatic wave plate is described herein. A system of making the achromatic wave plate is also described herein. A non-transitory computer-readable storage medium may have an executable stored thereon, which when executed instructs a processor to perform the methods described herein.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An achromatic wave plate, comprising:
a substrate; and
a twisted nematic liquid crystal polymer film applied on a surface of the substrate, wherein:
the twisted nematic liquid crystal polymer film comprises a plurality of layers; and
each layer comprises a negative dispersion twisted nematic liquid crystal polymer.

2. The achromatic wave plate of claim 1, wherein the twisted nematic liquid crystal polymer film is flexible for lamination of curved surfaces.

3. The achromatic wave plate of claim 1, wherein each layer of the negative dispersion twisted nematic liquid crystal polymer aligns a next layer during application.

4. The achromatic wave plate of claim 1, wherein the plurality of layers form a monolithic structure.

5. The achromatic wave plate of claim 1, wherein an achromaticity of the achromatic wave plate is in forward and backward propagation.

6. The achromatic wave plate of claim 1, wherein the achromatic wave plate is to provide full wave retardation, half wave retardation, or quarter wave retardation.

7. The achromatic wave plate of claim 1, wherein a spectral performance of the achromatic wave plate is about 1 across a visible spectrum of wavelengths.

8. The achromatic wave plate of claim 1, wherein the achromatic wave plate has an angular performance of about 30 degrees of angle of incidence.

9. An achromatic wave plate, comprising:
a substrate; and
a negative dispersion A-plate material film applied on a surface of the substrate, wherein the negative dispersion A-plate material film comprises a plurality of layers.

10. The achromatic wave plate of claim 9, wherein the negative dispersion A-plate material film is flexible for lamination of curved surfaces.

11. The achromatic wave plate of claim 9, wherein the plurality of layers form a non-continuous structure.

12. The achromatic wave plate of claim 9, wherein an achromaticity of the achromatic wave plate is in forward and backward propagation.

13. The achromatic wave plate of claim 9, wherein the achromatic wave plate is to provide quarter wave retardation.

14. An optical lens assembly, comprising:
a plurality of optical elements aligned along an orthogonal axis of each optical element; and
an achromatic wave plate, comprising:
a substrate; and
a twisted nematic liquid crystal polymer film applied on a surface of the substrate, wherein:
the twisted nematic liquid crystal polymer film comprises a plurality of layers; and
each layer comprises a negative dispersion twisted nematic liquid crystal polymer.

15. The optical lens assembly of claim 14, wherein the twisted nematic liquid crystal polymer film is flexible for lamination of curved surfaces.

16. The optical lens assembly of claim 14, wherein each layer of the negative dispersion twisted nematic liquid crystal polymer aligns a next layer during application.

17. The optical lens assembly of claim 14, wherein the plurality of layers form a monolithic structure.

18. The optical lens assembly of claim 14, wherein an achromaticity of the achromatic wave plate is in forward and backward propagation.

19. The optical lens assembly of claim 14, wherein the achromatic wave plate is to provide full wave retardation, half wave retardation, or quarter wave retardation.

20. The optical lens assembly of claim 14, wherein the substrate is one of the plurality of optical elements of the optical lens assembly.
